(19) United States
(12) Patent Application Publication
(10) Pub. No.: US 2009/0258187 A1
(43) Pub. Date: Oct. 15, 2009

(54) PROTECTIVE COATING FOR GLASS MANUFACTURING AND PROCESSING INTO ARTICLES

(76) Inventors: Michael Donavon Brady, Woodbury, MN (US); Mike Xu Ouyang, Painted Post, NY (US); Yale Pan, Painted Post, NY (US); Robert Sabia, Corning, NY (US); Yawei Sun, Horseheads, NY (US); David Alan Tammaro, Painted Post, NY (US); Qing Ya Wang, Minghang District (CN)

Correspondence Address: CORNING INCORPORATED, SP-TI-3-1, CORNING, NY, 14831, US

(21) Appl. No.: 12/418,954

(22) Filed: Apr. 6, 2009

Related U.S. Application Data
(60) Provisional application No. 61/123,713, filed on Apr. 10, 2008.

(51) Int. Cl. B32B 3/10; B32B 3/00; C03C 19/00

(52) U.S. Cl. 428/131; 428/156; 65/23

(57) ABSTRACT

The invention is directed to a method of protecting a glass surface during transportation and/or process using an aqueous solution of an acrylic material to protectively coat the surface of the glass sheet. The acrylic protective coating may be applied by dipping, roller applying or spraying the coating on the glass. The coating is then cured, dried or baked in an oven. Subsequently, the glass sheet may be scored and separated into individual glass article blanks for further processing; for example, edge grinding to produce smooth edges and drilling/milling to produce openings such as holes in the surface of the glass. When processing of the glass article is completed, the protective coating can be removed or the article can be shipped to the end used who can remove the coating using an aqueous solution of pH≧12 to remove the coating.

### CROSS-REFERENCE TO RELATED APPLICATIONS

This application claims the benefit of priority under 35 U.S.C. § 119(e) of U.S. Provisional Application Ser. No. 61/123,713 filed on Apr. 10, 2008.

### FIELD

The invention is directed to a protective coating that can be applied to a glass surface to protect it during transportation and further processing into articles.

### BACKGROUND

Many uses of glass, including LCD glass, require a very clean glass surface that is substantially free of particle and organic contaminants. When exposed to the environment, glass can quickly become contaminated with organic contaminants, with contamination being observed within a few minutes. Cleaning processes currently used for cleaning LCD glass often involve several steps and require a variety of chemicals. There is a need, therefore, for a method of protecting a glass surface from ambient contaminants during manufacture, shipping, and storage to minimize or even eliminate the need for chemicals to provide a clean glass surface.

In addition to environmental/organic-materials contamination, the procedures that are used to cut and grind glass surfaces and edges often generate small glass chips (e.g., chips having a size greater than 1 micron and less than about 100 microns). Some of these particles irreversibly adhere to the clean glass surface, rendering the glass useless for most applications. This is particularly a serious problem in the case of LCD glass surfaces.

LCD glass can be made by a fusion draw process, which yields flat, smooth glass surfaces, which can be cut or ground to the desired size. Some of the glass chips generated from the cutting process originate from the surface of the glass. When the flat surface of these chips comes into contact with the surface of the glass plate, there can be a large contact area between the chips and the glass surface which promotes strong adhesion. If a water film condenses or has condensed between these two surfaces, permanent chemical bonding may occur, in which case the adhesion of the glass chips to the surface becomes irreversible. This may make the glass useless for LCD applications.

One known method for protecting glass sheets, specifically, sheets of LCD glass, is to apply a polymer film on both major surfaces of the glass to protect the glass during the scoring, breaking, and beveling processes. In a typical method, one major surface has a polymer film attached with an adhesive, and the other major surface has a film attached by static charge. The first film is removed after the edge finishing (cutting or grinding) of the sheet is completed, and the second film is removed prior to the finishing process. Although the adhesive-backed film protects the surface from scratching by the handling equipment, it causes other problems. For example, the polymer film may entrap glass chips produced during the finishing process, leading to a build up of glass chips and scratching of the glass surface, particularly near the edges of the surface. Another problem with the adhesive-backed film is that it may leave an adhesive residue on the glass surface. There is a need, therefore, for a method of protecting a glass surface from chip adhesion that does not leave any residual coating on the glass surface, and for a method of temporarily protecting glass surfaces, whereby a glass article with a clean, coating-free surface can be readily obtained for further use.

Removability of the coating used to temporarily protect LCD glass is another important consideration. Manufacturers of liquid crystal displays use LCD glass as the starting point for complex manufacturing processes, which typically involve forming semiconductor devices, e.g., thin film transistors, on the glass substrate. To not adversely affect such processes, any coating used to protect LCD glass must be readily removable prior to the beginning of the LCD production process.

Thus, it would be desirable to have a coating that possesses the following characteristics:
(1) the coating should be one that can be readily incorporated in the overall glass forming process, specifically, at the end of the forming process, so that newly formed glass is substantially protected immediately after it is produced, be environmentally safe, be easy to spread across the glass surface using conventional techniques (e.g., spraying, dipping, flooding, meniscus, etc.), and be water resistant;
(2) the coating should protect the glass from chip adhesion resulting from cutting and/or grinding of the glass sheet, as well as the adhesion of other contaminants, e.g., particles, that the glass may come into contact with during storage and shipment prior to use;
(3) the coating should be sufficiently robust to continue to provide protection after being exposed to substantial amounts of water during the cutting and/or grinding process;
(4) the coating should be removable, either substantially or completely, from the glass prior to its ultimate use in order to minimize the number of particles present on the glass surface by detergents or non-detergents; and
(5) the coating once applied to the glass does not stick to interleaf paper between sheets of glass once the coated glass has been stacked, or in the event interleaf paper is not used, that the coating does not stick to itself, i.e. block up. Beneficially, the use of a coating with beads may eliminate the need for interleaving paper.
   The methods described herein satisfy this long standing need in the art.

### SUMMARY

In one embodiment the invention is directed to a method for preparing a glass article which comprises forming a glass sheet; protecting the surfaces of the drawn glass sheet applying a protective coating material to said sheet after forming, said coating material being selected from the group consisting of acrylic or methacrylic materials including acrylic acid and/or methacrylic acid copolymers; curing the protective coating on the glass; scoring the glass and breaking the glass along the score marks to form an article blank; finishing the edges of the glass to thereby produce a glass article; and removing the protective coating from the glass article. The method includes no lapping, grinding or polishing steps to remove debris or scratches from the surface of the glass article. In a further embodiment the protective coating is applied to the glass as an aqueous pH≧9 solution, in which the said coating material is dissolved at a set concentration in the range of 1 wt % up to 50 wt % depending on, for example, the solubility of the selected coating material, the thickness of the desired coating, the temperature at which the coating is applied. In yet another embodiment the protective coating selected from the group consisting of acrylic and methacrylic materials and is applied to the glass as an aqueous pH≧9 solution, preferably at a pH≧10 solution. In a further embodiment the protective coating after drying is removed from the glass using an aqueous pH≧12 solution, at a temperature in the range of 40-100° C., preferably 50-80° C., more preferable at 60-70° C., of at least one selected from the group consisting of a detergent, sodium hydroxide, potassium hydroxide and ammonium hydroxide, including aqueous mixtures thereof. The solutions used to remove the coating are aqueous-based, with the coating dissolution mechanism being accelerated by increasing the time and temperature of the coating removal step, as well as mixture purity of the coating removal solution in terms of supplying the glass with fresh solution as the coating is dissolved and rinsed away. Thus, the aqueous coating solution could be applied to the glass surface at a pH>12 and it could also be removed at a pH>12 provided that the solution used to remove the coating material is a clean or fresh solution containing little or no coating material (that is, the removal solution is relative pure with regard to amount of coating material it contains).

The invention is further directed to A method for preparing a glass article which comprises forming a glass sheet; protecting the surfaces of the drawn glass sheet applying a protective coating material to said sheet after forming, said coating material being selected from the group consisting of acrylic or methacrylic materials including acrylic acid and methacrylic acid copolymers; curing the protective coating on the glass; scoring the glass and breaking the glass along the score marks to form an article blank; further processing the article blank using one or a plurality of the steps of grinding, milling, drilling to produce one or a plurality of openings in the glass; finishing the edges of the glass to thereby produce a glass article; and removing the protective coating from the glass article. The method includes no lapping, grinding or polishing steps to remove debris or scratches from the surface of the glass article. In another embodiment the protective coating is applied to the glass as an aqueous pH≧9 solution. In a further embodiment the protective coating selected from the group consisting of acrylic and methacrylic materials and is applied to the glass as an aqueous ≧9 solution, preferably at a pH≧10. The protective coating is removed from the glass using an aqueous pH≧12 solution of at least one selected from the group consisting of a detergent, sodium hydroxide, potassium hydroxide and ammonium hydroxide, including aqueous mixtures thereof. Sodium hydroxide, potassium hydroxide and ammonium hydroxide, including mixtures are also used to adjust, as needed, the pH if the aqueous acrylic material solution prior to its being applied to the glass.

The invention is also directed to a small glass article made of cut/scored and untapped fusion drawn glass having a thickness of greater than 0.3 mm and including at least one feature, said feature being selected from the group consisting of an opening through the surface of the glass, a cavity of any shape on a surface of the glass, and a “writing” on a surface of the glass. In an embodiment the glass has a thickness in the range of 0.3 mm to 0.7 mm. In another embodiment the glass has a thickness in the range of 0.3 mm to 0.7 mm.

### BRIEF DESCRIPTION OF THE DRAWINGS

FIG. 1 is a schematic illustrating dipping of a glass sheet in a coating bath and drying the coated glass in an oven.

FIG. 2 is a graph illustrating of viscosity vs. concentration of an acrylic coating material used in a coating bath.

FIG. 3 is a graph illustrating of viscosity vs. temperature of an acrylic coating material (12% acrylic concentration) used in a coating bath.

FIG. 4 is a schematic illustrating roller coating of a glass sheet.

FIG. 5 is a schematic illustrating the use of a spray gun to spray the coating on a glass sheet.

FIG. 6 represent a Newfield view of a polished glass surface.

FIG. 7 represent a Newfield view of an unpolished fusion glass surface in accordance with the invention.

FIG. 8 represents AFM results for polished glass surface.

FIG. 9 represents AFM results for an unpolished fusion glass surface in accordance with the invention.

FIG. 10 is a photograph illustrating that when attacked by a 10% HF solution thicker films peel-off more slowly than thinner films.

FIG. 11 is an illustration of a coated glass article with the protective coating on its surface as viewed at 50× magnification using an optical microscope.

### DETAILED DESCRIPTION

The invention relates to the use of a protective coating to lower manufacturing costs for finishing (i.e., edging, drilling, lapping, polishing) of fusion drawn glass, particular glass that is intended for use in mobile or non-mobile display applications such as cell phone covers and touch screens. As used herein the term “glass” refers to any glass that can be used in display applications, and in preferred embodiment to fusion drawn and slot drawn glass. Fusion drawn glass is used herein to exemplify the invention. As also used herein the terms “cut” and “scored and broken” are mean that a large glass sheet is formed and is made into smaller sheets or glass blanks by use of a saw or water jet [cutting], or scratching the surface with a tool (for example. a diamond or silicon carbide tipped tool) and then separating the scored glass in smaller pieces [scored and broken], or heating with a laser with or without thermal shock cooling by air or liquid and with or without score initiation by a scratch.

Traditional finishing of glass, especially for mobile display applications, requires meeting stringent geometrical requirements for high throughput manufacturing processes, producing tens of thousands of parts per day. In order to meet these throughput requirements, significant handling issues are evident in manufacturing, from the initial score/break of sheet glass through the final polishing of the transmitting surface. Such handling, as well as the discrete process steps, induces surface scratches and checks that significantly impact final yields. For example, it has been found that the current finishing techniques known in the art result in final product scratch losses in the range of 15-20%.

The present invention describes a method for protecting the glass surfaces during processing, offers significant cost savings by protecting surfaces from handling damage, protects surfaces from damage induced during edge grinding and hole/slot drilling/machining, enables easy cleanability in terms of removing glass chips from the surface without inducing scratching, has the ability to coat in mass production, and result in limited to no post-edging lapping and polishing. The last advantage, limited to no post-edging lapping and polishing, is important to enabling both the use of thinner incoming glass (and thus lowering glass costs in terms of price per square foot) and eliminating costly processing steps.

The present invention relates to the use of a high pH, aqueous soluble coating materials (for example, acrylic and acrylic acid copolymers, for example, ethylene acrylic acid copolymers, methacrylate and methacrylic acid copolymers, cellulosic coatings, water-soluble polyester coatings, and other water soluble materials known in the art that can be removed using a water-based, non-abrasive cleaning method) to protect fusion drawn glass surfaces during separation and machining process steps used in manufacturing discrete parts for mobile and non-mobile display applications including, without limitation, transparent protective covers and touch screens. Acrylic materials are preferred. The materials should be insoluble or sparingly soluble in water at neutral pH, but soluble to at least 20 wt % at a pH≧9. In addition, after the material has been cured (dried, baked, infrared heated, microwave heated, etc.) on the glass surface it should be removable by using an aqueous pH≧12 solution as described herein. The cured coating can also be removed by using a basic detergent solution (or other solution as described herein) of pH>9-10, but such solutions have a low rate of polymer dissolution and requires a longer time to remove the polymer. Hence, solutions of pH≧12 are preferred due to their favorable rate of removing the polymer. The rate and completeness of removal are also driven by rinse solution purity, in terms of continually supply fresh detergent (or otherwise noted) solution to the glass surface and rinsing away the dissolved coating.

Ideally the use of the coating material will start with coating the glass in sheet form prior to score/break. During the score/break step or process the coated surfaces are protected from scratches typically induced via handling. During subsequent edge grinding and (if applicable) hole/slot drilling/milling step(s) the coating protects the surfaces from damage typically induced from the holding chuck and debris. As a result of these performance benefits resulting from use of the coating, subsequent lapping and polishing steps can be reduced if not eliminated. In addition, the surface coating is utilized to protect part surfaces during stacking such as is used in low-cost edge grinding/polishing operations where multiple pieces of glass have their edges ground and/or polished simultaneously.

As a result of using a protective polymer coating on the glass prior to processing to make an individual display and/or cover class, significant cost savings are realized from:

(1) decreasing yield losses from surface scratches and checks,

(2) eliminating process steps such as lapping and polishing, and

(3) the use of thinner incoming glass thus yielding a lower cost per square foot.

The protective coating can be applied in bulk to either large sheets or individual parts by means of, for example, dipping, spraying, or spinning. The coating is soluble in high pH water for ease of removal, again in bulk. The coating, coating process, removal process, and waste are non-toxic, environmentally friendly. The thickness of the coating can be any thickness desirable for the intended further processing and it can be applied in a single step or multiple steps. For most uses the thickness of the coating is in the range of 1 to 10 μm. When a glass article or glass sheet is to be shipped to a purchaser, thicker coatings, 5 to 20 μm, may be applied to aid in protecting and cushioning the glass during shipment. Generally, when thicker coatings are to be applied the use of two or more coating steps (for example, dipping, roller application or spraying) is preferred to insure a more uniform coating over the surface of the glass.

FIG. 1 illustrates a dipping process to coat a glass sheet 10 which can be either a large sheet that will subsequently be cut to the desired size or a sheet that has been already cut to the desired size. The sheet was held along its top edge and dipped in to a bath 12 containing the protective coating. After coating the sheet is moved into a tunnel oven 14 where is it is dried at a temperature in the range 25-200° C., preferably a range of 50-160° C. for a time on the range of 10-30 minutes, preferably 10-20 minutes to produce a glass sheet with protective coating 16.

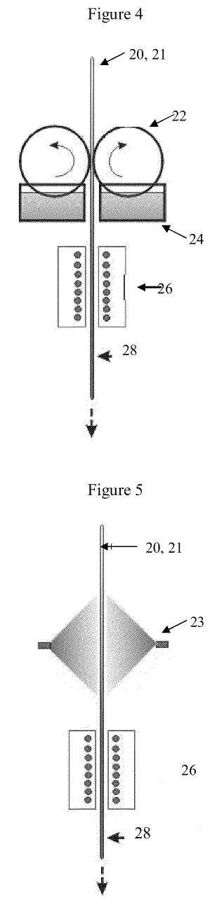

FIG. 4 illustrates a process for applying the coating to a glass sheet 20 using rollers 22 (which continuously rotate into and out coating bath 24) to a glass sheet as the glass sheet 20 comes from the bottom of the draw 21 (“BOD”). After the coating has been applied the sheet is passed through an oven 26 which dries the coating on the glass. The glass sheet is then scribed and separated (indicated as numeral 28) into glass articles of a desired size for the application in which it is to be used; for example, a display and/or touch screen for a telephone, ATM machine, personal music player or other device. The individual glass articles are then processed in further steps to provide the final, finished article. Such further steps include grinding, milling and drilling to produce any desired opening in the glass and/or finishing the edges of the glass.

FIG. 5 illustrates a process for in which the coating from a coating is applied to a glass sheet 20 (coming from BOD 21) using a spray gun 23. After the coating has been applied to the glass it is dried in an oven 26 before the glass is scribed and separated (indicated as numeral 28) into glass articles of a desired size for the application in which it is to be used; for example, a display and/or touch screen for a telephone, ATM machine, personal music player or other device. The individual glass articles are then processed in further steps to provide the final, finished article. Such further steps include grinding, milling and drilling to produce any desired opening in the glass and/or finishing the edges of the glass.

Glass articles can also be coated using spin coating methods. In the spin coating process a glass article is held in place on a rotatable table, coating solution is applied at the center of the piece and the piece rotated (spun) to make the coating move from the center to the edges, thus coating the article. Addition coating solution can be applied while the article is being spun. Once the article has been coated it is dried in an oven or it can be dried while one the table, for example, by the use of heat (as from a heated blower or heat gun), or infrared or microwave radiation. If the thickness of the polymer layer on the glass is not sufficiently thick after drying, the article can be recoated in a second coating step. Spin coating is particularly suitable for circular or oval articles or glass sheets while the dipping and spraying processes are more suitable for multiple shapes of glass such as large oval, rectangular, square, hexagonal, triangular or other multiple-sided shapes.

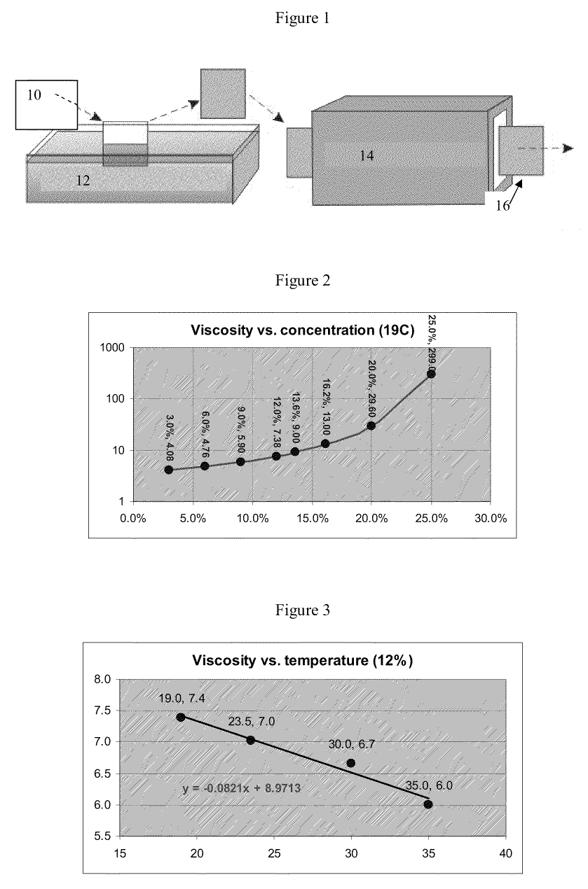

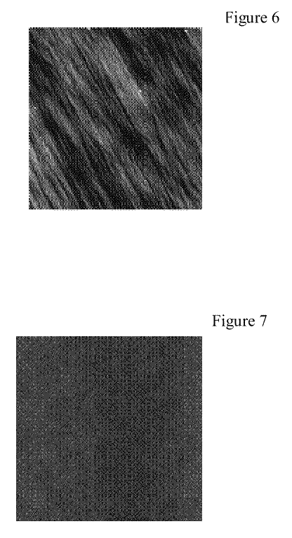

FIG. 2 is a graph illustrating viscosity vs. concentration for typical water soluble acrylic coating that was used in practicing the invention. The concentration of acrylic polymer is in the range of 3-25% and the viscosity of the resulting solutions in the range of 4-300 poise. The viscosity can change depending on the exact polymer material being used. Materials having a high viscosity can also be used, but materials having a viscosity of less than 500 poise at a concentration in the range of 3-25% are preferred. FIG. 3 is a graph illustrating viscosity vs. temperature for a 12 wt % concentration of an acrylic polymer in water. The temperature range in FIG. 6 is 15-40° C. For the data points (black circles) shown in FIG. 3 the viscosity is in the range 7.4 to 6.0. the viscosity decreasing as the temperature increases. The plotted data shows the temperature and viscosity for each point; for example, “19.0, 7.4” means the temperature was 19.0° C. and the viscosity was 7.4 poise.

Tables 1 and 2 below give the thickness of the cured (oven dried) polymer layer after a single or a double coating thickness has been applied to the glass using the dip coating method. Acrylic material concentrations of 3%, 6%, 9% and 12% were used and the thickness was determined in micrometers (“μm”).

TABLE 1
Single Thickness, Acrylic Polymer

| | | Acrylic Concentration, | | | |
|---|---|---|---|---|---|
| Curing | | wt %, aqueous Solution | | | |
| Temperature, ° C. | Time, min | 12% | 9% | 6% | 3% |
| 160 | 12 | 2.4 μm | 1 μm | 1.2 μm | 0.4 μm |
| 180 | 15 | 1.5 μm | 0.95 μm | — | — |
| 200 | 20 | 2.0 μm | 1.3 μm | — | — |
| 220 | 20 | 1.4 μm | 1.3 μm | — | — |
| 250 | 20 | 0.4 μm | 0.3 μm | — | — |

TABLE 2
Double Thickness, Acrylic Polymer

| | |
|---|---|
| | Acrylic Concentration, |
| Curing | wt %, aqueous Solution |

| Temperature, ° C. | Time, min | 12% | 9% |
|---|---|---|---|
| 160 | 12 | 5.5 μm | — |
| 160 | 15 | 5.2 μm | 3.8 μm |
| 160 | 20 | 5.0 μm | 3.0 μm |
| 180 | 15 | 5.0 μm | 2.8 μm |
| 220 | 15 | 2.0 μm | — |

Traditional glass manufacturing processes require significant care be taken in order to protect glass surfaces from scratches and that checks need to be made during significant downstream processing (that is, in steps after glass sheet formation—for example, during grinding, milling, drilling, etc.). If debris is present on the glass it must be removed to prevent scratching from indentation or sliding contact during down-stream processing. If it is not removed or cannot be removed, then part rejection at final inspection is possible or even likely. Conversely, a protective laminate or cover film can protect surfaces from down-stream damage dictated by particle/debris contamination and friction/wear/scratch/indentation with the surface. For this type of protection the film must satisfactorily protect the surface during processing and be removable after processing is complete. Consequently, adhesive strength, along with other properties (for example, ease of removal without leaving any residue) is critical.

While adhesive films that are applied as laminates offer varying degrees of adhesive strength and performance during machining steps including grinding/drilling/milling, these have not been found completely satisfactory because the laminate film can be peeled back or removed at the work site such as the when it is necessary to drill a hole or grind/mill an edge. While some commercially available laminating materials have been found useful in, for example, large sheet edging, their utility has been found to be limited. For example, one commercially available laminate material (material 1) offers limited adherence properties that exhibits a certain degree of acceptable peeling back from the surface during edging, and is easily removable by the customer when the final product is shipped to them. A second commercially available laminate material (material 2) offers significant adherence performance and is acceptable in the edging process, but is has an undesirable degree of removal difficulty by the customer. However, neither laminate performs adequately for machining of holes or slots through the final part surface. For example, due to its low adherence performance material 1 delaminates when penetrated by a tooling bit, and debris from the laminate material imbeds in the tool bit and reduces its effectiveness. The present invention offers a manufacturing method for protecting glass surfaces during machining, and eliminates scratches from handling, for example, from glass-to-glass contact, and also damage from fixturing typically in direct contact with the glass.

Use of the method of the invention also results in significant cost savings as result of the following:
(1) Protection from handling and process induced surface scratches, thus reducing yield losses from scratches, which losses can be in the range of 15-20%.
(2) The elimination of process steps such as lapping and polishing, when, when the coating of the invention is used, have been found to be unnecessary in removing surface damage after edge grinding, hole drilling, and slot milling due to the beneficial surface protection provided by the coating
(3) Enabling the use decreased incoming glass thickness, that is, thinner glass, and thus glass cost by means of eliminating the need for to lap/polish and the removal of excess glass thickness needed to allow these process steps.

Coating material requirements are for a water soluble acrylic or methacrylate coating material, the acrylic or methacrylate being soluble at a pH≧9 that can be thermally cured at a temperature below 200° C., preferably below 160° C., to generate a hard protective layer having a thickness in the range of 1-15 micrometers (em), preferably 2-10 micrometers. In addition, the coating material should be insoluble in oil, pH neutral water (that is, pH ˜7) and in slightly alkaline aqueous detergent solutions having a pH up to approximately pH 9. Further, the polymer film, after drying, should be removable using an aqueous solution have a pH≧10. An example, without limitation, of a suitable acrylic material is (Product Code MP-4983R from Michelman, Inc. (Cincinnati, Ohio) which can be applied to the glass surface via dipping, spraying, or spinning, and for which there is no chemical waste stream; that is the coating and all application/removal solvents can be disposed via the sanitary drain.

The invention has three general parts:
(1) Coating materials.
(2) The process for applying and removing the acrylic materials on glass surface off-line or online at bottom of draw (BOD).
(3) Applications of protective coating.

Coating Materials:

There is a wide range of materials available for protective coating. The most common ones are:
A. Acrylic and acrylic acid copolymer materials; for example, the Michelman MP4983R-PL material mentioned above. This inexpensive material can be applied to glass by dipping at 3-25% concentration and then thermally cured at temperatures in the range of 25-250° C. The coating is easily removed by high pH solvent, for example, SEMICLEAN™, and Conrad 70™ detergents (available from Decon Labs, Inc., Bryn Mawr, Pa.) at 40-100° C., preferably 50-80° C. The temperature will be dependent on the material used to remove the coating.
B. Solvent-based highly fluorinated functionalized perfluoropolyethers (PFPEs) that have liquid-like viscosities. These materials can be cured into tough, highly durable elastomers that exhibit the remarkable chemical resistance of fluoropolymers such as Teflon. These materials can be removed with a variety of organic solvents; for example, acetone and methyl ethyl ketone.
C. Commercially available paints. Most paints can be thermally cured at 25-100° C. The cured paint can be removed by organic solvent (for example, acetone), or by boiling in hot water to swell the coating after which it can easily be peeled off.

For glass finishing protection, the coating must have good adhesion on glass to withstand water jet pressures which are used to cool tool bits and remove debris from the part/tool interface during wheel grinding and CNC machining process steps. The coating should also be sufficient brittle in order to prevent jamming of the finishing tooling. Acrylics, ethylene acrylic acid copolymers and methacrylates are such materials; and for these materials the coating modulus increases with increasing curing temperature. Further, it was found that the acrylic/ethylene acrylic acid copolymer coating survived and remained intact after the following sequence of process:

1. Scribing the glass and breaking it to the scribed size.

2. CNC machining to form complicated shapes with a hole and/or a slot.

3. Stacking a plurality of glass articles or sheets for edge and hole polishing.

After the glass articles or sheet has gone through the above processes, the acrylic coating was removed by dipping the article or sheet into 5% aqueous solution of SEMICLEAN detergent in deionized water for 10 minutes at 70° C. No scratches were found on the glass surfaces and the surfaces were clean, without any debris or other material.

Process for Applying/Removing Acrylic Materials on Glass Surface Either Off-Line or On-Line at Bottom of Draw (BOD):

The application of acrylic coatings requires a coating application step and a post-application baking or drying step. There are several methods suitable for applying an acrylic coating to glass sheet at the bottom of the draw. These are dipping, roller coating and spray coating, all with a drying/baking step after the acrylic coating has been applied at BOD.

Dipping+Baking
(1) Cut size glass goes through a solvent bath filled with protective coating solvent. Then, coated glass goes through a tunnel oven for baking. See FIG. 1.
(2) Coating thickness is controlled by solvent viscosity and glass pulling speed. Oven baking temperature and time determines coating hardness and adhesion. Typical Acrylic dipping parameters are shown in FIG. 2, and Tables 1 and 2.
(3) Adhesion of the coating on glass is sensitive to the coating process. Adhesion was tested by dipping glass in a 10% aqueous HF solution to determine how well the acrylic coating will survive at glass finishing processing by under a water jet. The samples were coated using 3%, 6%, 9% and 12% aqueous solutions, baked at 160° C. for 12 minutes and then ) treated with 10% HF for 30 seconds. While the polymer coating not protect against 10% HF attack, the speed at which the polymer film was attacked and peeled-off from the glass decreased as the thickness of the polymer coating increased.

Roller Coating
(1) Coating using rollers is another way to protect the glass surfaces.
(2) The protectively coated glass is then cut to the desired piece/article size and is ready for shipping and/or further processing such as undergoing grinding, milling and/or hole/slot drilling.
(3) See FIG. 4 for roller coating illustration.

Spray+Dry
(1) By spraying protective coating solvent, and the post baking at the BOD continuous glass sheet production line, the glass sheet is given immediate protection after it is made.
(2) The protectively coated glass is then cut to the desired piece/article size and ready for shipping and/or further processing such as undergoing grinding, milling and/or hole/slot drilling.
(3) See FIG. 5 for spray coating illustration.

Protective Coating for Glass Machining

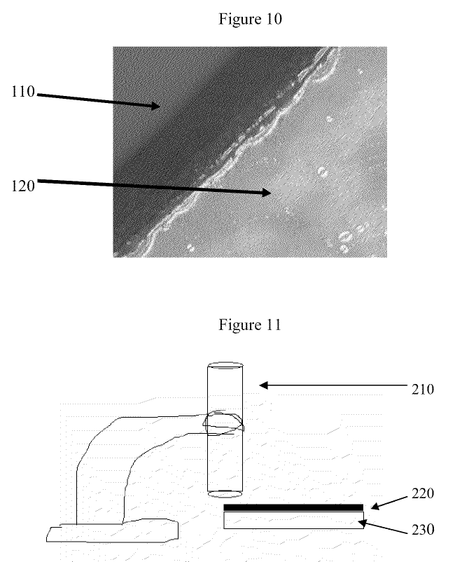

Using above protective coating, after forming the desired size glass articles the articles were finished by CNC (computer numerical control) shaping, precision grinding, edge chamfer, hole and slot drill with chamfer. A coated glass article with the protective coating on its surface was viewed at 50× magnification using an optical microscope as is illustrated in FIG. 11. FIG. 10 shows that coating survived the above process steps. In FIG. 10, numeral 110 represents a black area caught from outside the glass and area 120 represents the protected glass area (the protective glass coating is visible in a color photograph but not in a grayscale or black/white photograph). Also visible is a very small area of uncovered glass (from the CNC machining) around the edge of the article, Between 110 and 120 one can see how the protective coating protected the glass during machining. In the color photograph the blue color is the coating film and the shining edge outside the blue film is the image of the glass edge. The image outside the glass edge becomes a gradually defocused image from the vertical side. The “circular” spots on top of the coating are coolant drops (coolant being used to prevent heating of the glass) that are produced during the CNC machining and are unrelated to the protective coating or the protective coating process. Once the processing of glass article is completed the coating was removed using, for example, 5% aqueous SEMICLEAN detergent, pH>12, at 70° C. for 10 minutes. The pristine fusion surface of the glass was well preserved and was without a scratch.

### Example

### Material and Application/Removal Methods

Material: MP-4983R from Michelman, Inc.
Application Method Dip coated into 6-9% acrylic material in water
Coating thickness: 2 micrometers
Second coating: Id desired, repeat dip coat to further increase coating thickness.
Thermally cure: Cured at 160° C. to promote machinability without delamination
Removal Method: 4% SemiClean KG detergent, pH>12, at 71° C. for 15 min; or Normal (“1N”)) KOH (pH=12) solution at 71° C. for 15 min.

The invention provides the following benefits, all of which translate to cost savings and thus lower cost manufacturing.

Protection from Handling and Process Induced Surface Scratches and Damage

(1) The coating offers protection from handling damage during score/break/storage from glass-to-glass contact, as well as protection during grinding/drilling/milling processes. In particular, the coating prevents damage to the glass from debris and from fixtures that come into contact with the glass during processing.

(2) As a result, process yield losses are minimized, saving as much as 15-20% of the selects (pieces or articles selected after grinding/drilling/milling) currently lost during final finishing.

Elimination of Process Steps

(1) By protecting glass surfaces from scratches and damage, lapping and polishing steps can be minimized if not completely eliminated.

(2) With less frequent and shallower damage, less (if any) material needs to be lapped from the surface in preparation for polishing (if needed).

(3) By means of minimizing/eliminating these lapping and polishing steps, significant cost savings can be realized in terms of equipment and facilities investment, as well as yield losses from these processes (e.g., part breakage during lapping/polishing)

Decreased Incoming Glass Thickness

(1) By eliminating/minimizing the need for lapping and polishing, thinner incoming glass thickness can be utilized. Glass is removed from articles during these processes. The ability to use thinner glass lowers the cost of the articles because in addition to eliminating the cost of the lapping/polishing steps, less glass is used.

(2) Significant cost savings can be realized by starting with thinner glass due to the fusion process having a set delivery rate to the draw, meaning that thinner glass is cheaper in terms of enabling a faster pull rate and higher throughput of drawn glass

Ease of Manufacturing

The high surface quality of fusion glass can now be utilized for the product, yielding a RMS roughness (by AFM of ˜0.2 nm with sub-0.5 nm deep high spatial frequency scratches and digs, vs. polished glass that typically exhibits ˜0.5 nm RMS roughness and >2.0 nm deep high spatial frequency scratches and digs.

The invention is also directed to a small glass article made of cut/scored and untapped fusion drawn glass having a thickness of greater than 0.3 mm and including at least one feature, said feature being selected from the group consisting of an opening through the surface of the glass, a cavity of any shape on a surface of the glass, and a “writing” on a surface of the glass. The thickness of the glass is typically in the range of 0.3-0.7 mm, preferable in the range of 0.3-0.5 mm. A “writing” means not only script, block or other forms of letters, but also symbols, logos and other items that are written on the surface of the glass but do not go through the glass to form an opening through the glass such as a hole or slot. A cavity means a depression in a surface of the glass that does not go all the way through the glass to form an opening and that can be used, for example, to accommodate an article such as a heat or pressure sensor, for example, heat or pressure from a person's finger. The article has an AFM surface roughness of ≦0.4 nm with sub-0.5 nm deep high spatial frequency scratches and digs. In preferred embodiments the AFM surface roughness is ≦0.2 nm. The glass article can be used is numerous devices; for example, personal music players, electronic book readers, personal desk assistants, small laptop or notebook computers, cell phones, GPS devices and other electronic devices.

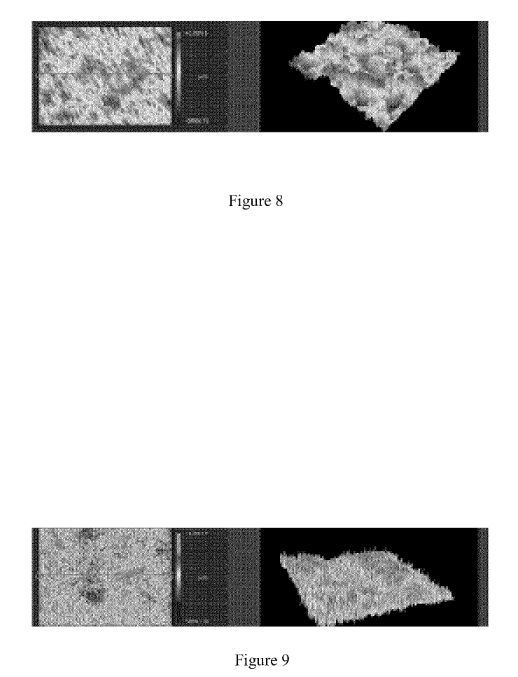

FIGS. 6 and 7 represent a Newfield view (scan size 120×180 μm) of a polished glass surface and unpolished fusion glass surface in accordance with the invention, respectively. FIGS. 8 and 9 Are AFM (atomic force microscopy) results for polished glass surface and an unpolished fusion glass surface in accordance with the invention, respectively. Table 3 summarizes the results from the Newfield and AFM images.

TABLE 3

Roughness (nm rms)

| Technique | Scan Size | Fusion | Polished |
|---|---|---|---|
| Newfield | 120 × 180 μm | 0.25 | 1.40 |
| AFM | 20 × 20 μm | 0.38 | 1.44 |

Various modifications and variations can be made to the materials, methods, and articles described herein. Other aspects of the materials, methods, and articles described herein will be apparent from consideration of the specification and practice of the materials, methods, and articles disclosed herein. It is intended that the specification and examples be considered as exemplary.

We claim:

1. A method for preparing a glass article which comprises:
forming a glass sheet;
protecting the surfaces of the drawn glass sheet applying a protective coating material to said sheet after forming, said coating material being selected from the group consisting of acrylic and methacrylic materials applied to the glass as an aqueous pH≧9 solution;
curing the protective coating on the glass;
scoring the glass and breaking the glass along the score marks to form an article blank;
finishing the edges of the glass to thereby produce a glass article; and
removing the cured protective coating from the glass article;
wherein the method includes no lapping, grinding or polishing steps to remove debris or scratches from the surface of the glass article.

2. The method according to claim 1, wherein the protective coating selected from the group consisting of acrylic and methacrylic materials and is applied to the glass as an aqueous pH≧10 solution.

3. The method according to claim 1, wherein the protective coating is removed from the glass using a an aqueous pH≧12 solution of at least one selected from the group consisting of a detergent, sodium hydroxide, potassium hydroxide and ammonium hydroxide.

4. A method for preparing a glass article which comprises:
forming a glass sheet having a thickness in the range of 0.3-0.7 mm;
protecting the surfaces of the drawn glass sheet by applying a protective coating material to said sheet after forming, said coating material being selected from the group consisting of acrylic and methacrylic materials applied to the glass as an aqueous pH≧9 solution;
curing the protective coating on the glass;
scoring the glass and breaking the glass along the score marks to form an article blank;
further processing the article blank using one or a plurality of the steps of grinding, milling, drilling to produce one or a plurality of openings in the glass;
finishing the edges of the glass to thereby produce a glass article; and
removing the cured protective coating from the glass article;
wherein the method includes no lapping, grinding or polishing steps to remove debris or scratches from the surface of the glass article.

5. The method according to claim 4, wherein the protective coating selected from the group consisting of acrylic, acrylic acid copolymer, ethylene acrylic acid copolymer, methacrylic acid, and methacrylic materials and is applied to the glass as an aqueous pH=10-12 solution.

6. The method according to claim 4, wherein the protective coating is removed from the glass using a an aqueous pH≧12 solution of at least one selected from the group consisting of a detergent, sodium hydroxide, potassium hydroxide and ammonium hydroxide.

7. A small glass article, said article being made of cut/scored and untapped fusion drawn glass having a thickness of greater than 0.3 mm and including at least one feature, said feature being selected from the group selected consisting of an opening through the surface of the glass, a cavity of any shape on a surface of the glass, and a “writing” on a surface of the glass.

8. The glass article according to claim 7, wherein said glass article has a thickness of the glass is in the range of 0.3-0.5 mm.

9. The glass article according to claim 7, wherein said glass article has a surface roughness of ≦0.4 nm with sub-0.5 nm deep high spatial frequency scratches and digs.

10. The glass article according to claim 7, wherein said glass article has a surface roughness of ≦0.2 nm and sub-0.5 nm deep high spatial frequency scratches and digs.

11. A glass article for use in hand-held electronic devices, small laptop computers and as touch screens, said device being made by a process comprising the steps of;
forming a glass sheet having a thickness in the range of 0.3-0.7 mm;
protecting the surfaces of the drawn glass sheet by applying a protective coating material to said sheet after forming, said coating material being selected from the group consisting of acrylic or methacrylic materials applied to the glass as an aqueous pH≧9 solution;
curing the protective coating on the glass;
scoring the glass and breaking the glass along the score marks to form a glass article blank;
further processing the article blank using one or a plurality of the steps of grinding, milling, drilling to produce one or a plurality of openings in the glass blank;
finishing the edges of the glass to thereby produce a glass article; and
removing the cured protective coating from the glass article using an aqueous solution of pH≧12;
wherein the method includes no lapping, grinding or polishing steps to remove debris or scratches from the surface of the glass article.

12. The glass article according to claim 11, wherein forming a glass sheet means fusion drawing a glass sheet to a thickness in the range of 0.3-0.7 mm.

13. The glass article according to claim 11, wherein drawing a glass sheet means fusion drawing a glass sheet to a thickness in the range of 0.3-0.5 mm

14. The glass article according to claim 12, wherein after processing according to steps of claim 12, said glass article has a surface roughness of ≦0.4 nm and sub-0.5 nm deep high spatial frequency scratches and digs.
